(19) United States
(12) Patent Application Publication
(10) Pub. No.: US 2015/0349971 A1
(43) Pub. Date: Dec. 3, 2015

(54) PROXIMITY-BASED CONFERENCE SESSION TRANSFER

(71) Applicant: Highfive Technologies, Inc., Redwood City, CA (US)

(72) Inventors: Shantanu SINHA, Palo Alto, CA (US); Jeremy ROY, Woodside, CA (US); Ching Yin Derek PANG, San Francisco, CA (US); Ohene Kwasi OHENE-ADU, Santa Clara, CA (US); Edward WEI, Palo Alto, CA (US); Sayli Anand BENADIKAR, Santa Clara, CA (US); Sankara Narayana Hemanth MEENAKSHISUNDARAM, Sunnyvale, CA (US)

(21) Appl. No.: 14/726,271

(22) Filed: May 29, 2015

Related U.S. Application Data
(60) Provisional application No. 62/005,425, filed on May 30, 2014.

(51) Int. Cl. H04L 12/18; H04W 12/08; H04W 4/02

(52) U.S. Cl. CPC H04L 12/1818; H04W 4/02; H04L 12/1822; H04W 12/08

(57) ABSTRACT

A method of proximity-based conference session transfer is disclosed. The method is implemented at a conference device and it starts with the conference device generating a conference session code based on an encrypted conference session message received from a conference server. The conference device communicates the conference session code to an area in proximity to the conference device, where a user device in the area in proximity to the conference device receives the conference session code and requests the conference server to coordinate the conference device to assume a conference session of the user device. The conference device then receives a message from the conference server requesting the conference device to assume the conference session of the user device, and it assumes the conference session of the user device by performing conference functions according to input from the user device.

### CROSS-REFERENCE TO RELATED APPLICATIONS

This application claims priority to U.S. Provisional Patent Application No. 62/005,425, filed on May 30, 2014. This application is related to co-pending U.S. patent application Ser. No. ______, Attorney Docket No. 9705P001, entitled “DOMAIN TRUSTED VIDEO NETWORK,” and co-pending U.S. patent application Ser. No. ______, Attorney Docket No. 9705P003, entitled “METHOD AND SYSTEM FOR MULTIPARTY VIDEO CONFERENCING,” both filed herewith, which are incorporated herein by reference.

### FIELD OF INVENTION

The embodiments of the invention are related to the field of conferencing. More specifically, the embodiments of the invention relate to a method and system for supporting a proximity-based conference session transfer.

### BACKGROUND

Conferencing is a technology that allows two or more locations to communicate by supporting simultaneous two-way audio/video transmission between locations. When the conferencing includes video transmission between the locations, it is generally referred to as video conferencing. Video conferencing uses audio and video transmission to facilitate communication between people at different locations and it reduces the need to travel for meetings and work collaboration, thus video conferencing has become popular in both residential and commercial settings.

Traditionally, conferencing involves two or more conference devices. FIG. 1 illustrates a traditional conferencing system. The conferencing system 100 contains conference devices 102 and 104, which are in two different conference rooms 152 and 154 respectively. Typically a conference device is a dedicated system that encodes/decodes (often compresses/decompresses) audio and video streams, and it may be coupled to a video monitor (e.g., a television) to display video and provide an audio output (e.g. a speaker). Both conference devices 102 and 104 are connected to network 170. A conference session is established between the conference devices through a handshake protocol. Then users participate in the conference session in conference rooms 152 and 154 through interaction with conference devices 102 and 104, respectively. The conference devices typically do not interact with user devices that users carry for the conference session and the users rely only on the conference devices exclusively for conferencing. The conferencing is fixed to the two conference devices 102 and 104 and therefore between the two conferences rooms 152 and 154 in which they are situated.

### SUMMARY

A method of proximity-based conference session transfer is disclosed. The method is implemented at a conference device and it starts with the conference device generating a conference session code based on an encrypted conference session message received from a conference server. The conference device communicates the conference session code to an area in proximity to the conference device, where a user device in the area in proximity to the conference device receives the conference session code and requests the conference server to coordinate the conference device to assume a conference session of the user device. The conference device then receives a message from the conference server requesting the conference device to assume the conference session of the user device, and it assumes the conference session of the user device by performing conference functions according to input from the user device.

An apparatus serving as a conference device is disclosed. The apparatus contains memory configured to store data and instruction, and processors configured to executed a network interface, a session code generator and a session coordinator stored in the memory. The network interface is configured to receive an encrypted conference session message from a conference server and communicate a conference session code to an area in proximity to the apparatus, where a user device in the area in proximity to the apparatus receives the conference session code and requests the conference server to coordinate the conference device to assume a conference session of the user device. The network interface is further configured to receive a message from the conference server requesting the apparatus to assume the conference session of the user device. The session code generator is configured to generate the conference session code based on the encrypted conference session message. The session coordinator is configured to assume the conference session of the user device by coordinating conference functions according to input from the user device.

A non-transitory machine-readable storage medium is disclosed. The non-transitory machine-readable storage medium has instructions stored therein, which when executed by a processor, causes the process to perform operations implemented at a conference device. The operations include generating a conference session code based on an encrypted conference session message received from a conference server. The operations further include communicating the conference session code to an area in proximity to the conference device, wherein a user device in the area in proximity to the conference device receives the conference session code and requests the conference server to coordinate the conference device to assume a conference session of the user device. The operations also include receiving a message from the conference server requesting the conference device to assume the conference session of the user device and assuming the conference session of the user device by performing conference functions according to input from the user device.

Embodiments of the disclosed techniques aim at securely transferring a conference session between a user device and a conference device. With secured information being transferred only to an area in a proximity to the conference device, the embodiments balance the convenience of using the conference device and the need for security of the conference session.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this specification are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 illustrates a traditional conferencing system.

FIG. 2 illustrates a conference system utilizing a conference device according to one embodiment of the invention.

FIG. 3 illustrates a process of supporting proximity-based conference session transfer according to one embodiment of the invention.

FIG. 4 illustrates messaging during a proximity-based conference session transfer according to one embodiment of the invention.

FIG. 5 illustrates initiating a conference device according to one embodiment of the invention.

FIG. 6 is a flow diagram illustrating a process of supporting proximity-based conference session transfer at a conference device according to one embodiment of the invention.

FIG. 7 is a flow diagram illustrating a process of supporting proximity-based conference session transfer at a user device according to one embodiment of the invention.

FIG. 8 is a block diagram illustrating an example of a conference device that may be used with one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. A “set,” as used herein refers to any positive whole number of items including one item.

An electronic device (e.g., a conference device, a user device, or a conference server) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals—such as carrier waves, infrared signals). In addition, such electronic devices include hardware, such as a set of one or more processors coupled to one or more other components—e.g., one or more non-transitory machine-readable storage media (to store code and/or data) and network connections (to transmit code and/or data using propagating signals), as well as user input/output devices (e.g., a keyboard, a touchscreen, and/or a display) in some cases. The coupling of the set of processors and other components is typically through one or more interconnects within the electronic devices (e.g., buses and possibly bridges). Thus, a non-transitory machine-readable medium of a given electronic device typically stores instructions for execution on one or more processors of that electronic device. One or more parts of an embodiment of the invention may be implemented using the electronic device.

A Paradigm for Conferencing

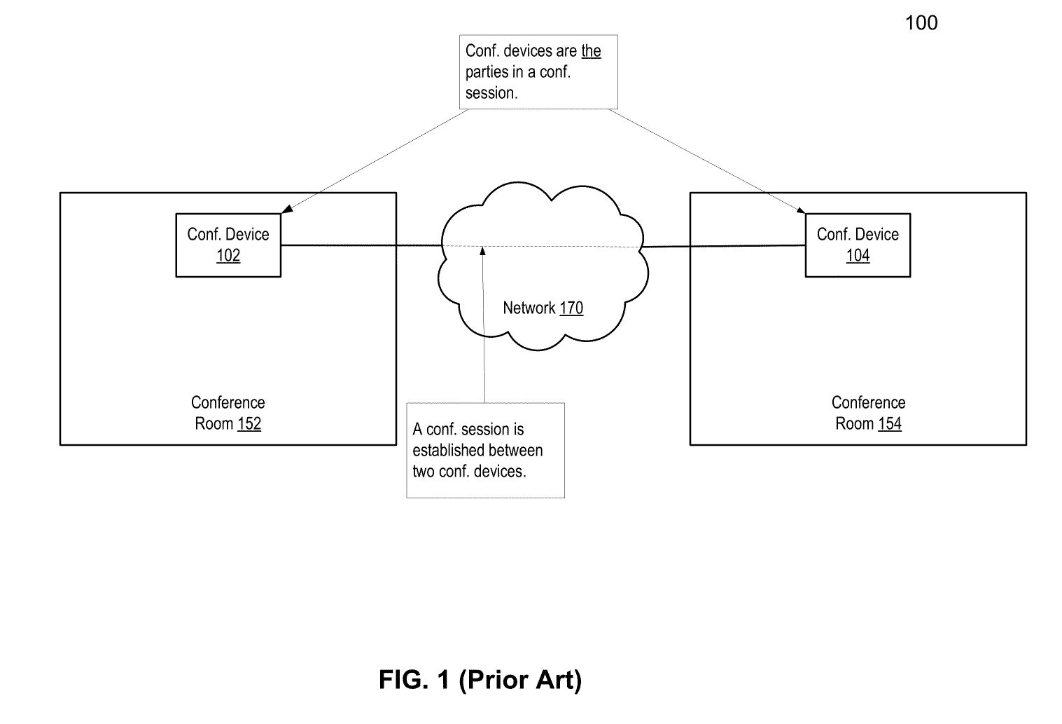

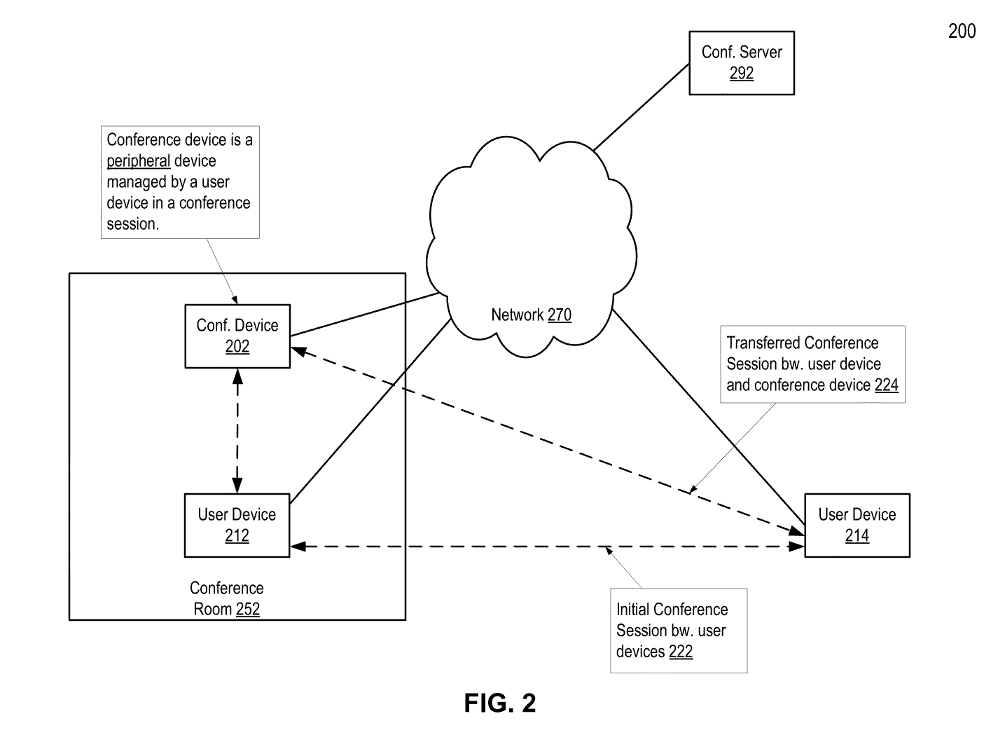

In the paradigm illustrated in FIG. 1, the conference devices are the parties of a conference session. The paradigm works when users generally stay near a conference room equipped with a conference device. However, users are more mobile than ever, and one or more parties may not be near a conference device. Counting on conference devices to be the parties for conferencing may no longer be practical. Also, users nowadays often carry user devices with high computing power that can encode/decode audio and video streams, and a user device often contains applications that the user likes to share with another user of a conference session. For example, a user may like to share a presentation or a video in a user device with participants of the conference session. The user may prefer to use these user devices for conferencing and also be able to share using the built-in infrastructure around the conference devices, and the challenge is to find a solution to effectively use both user devices and conference devices. Contrast to the existing paradigm, embodiments of the disclosed techniques utilize conference devices as peripheral devices of user devices. FIG. 2 illustrates a conference system utilizing a conference device according to one embodiment of the invention. The conference system 200 contains user devices 212 and 214, conference device 202, and conference server 292, and they are coupled to network 270.

User devices 212 and 214 are electronic devices capable of performing conferencing related tasks (e.g., encoding/decoding audio/video streams), and they may be workstations, laptops, netbooks, tablets, palm tops, mobile phones, smartphones, multimedia phones, Voice Over Internet Protocol (VOIP) phones, terminals, portable media players, GPS units, wearable devices, gaming systems, set-top boxes, and Internet enabled household appliances.

Conference device 202 is also an electronic device capable of performing conferencing related tasks. Because conference device 202 is often dedicated to conferencing, its computing resources are often tailored for conferencing functions thus it may be desirable to utilize the conference device for a conference session if a user is near the conference device. A conference device generally supports video conferencing and it often contains or is coupled to a monitor.

Conference server 292 is an electronic device capable of coordinating conference sessions. Conference server 292 may coordinate a large number of concurrent conference sessions, and each conference session may be between two or more electronic devices (in one embodiment, each conference session may support up to 16 electronic devices).

Network 270 may be any type of network such as a local area network (LAN), a wide area network (WAN), such as the Internet, a corporate intranet, a metropolitan area network (MAN), a storage area network (SAN), a bus, or any combination thereof, with constituent links of these networks being wired and/or wireless.

In one embodiment, a conference session is initiated between user devices 212 and 214 as illustrated at reference 222. The conference session may be initiated through coordination of conference server 292. Then the conference session can be transferred to be between conference device 202 and user device 214 as illustrated at reference 224. This transfer is feasible when user device 212 is in an area in proximity to conference device 202. In one embodiment, after the transfer, the conference session is between conference device 202 and user device 214, while user device 212 remotely manages conference device 202. In other embodiments, user device 212 can remain part of the conference session such as where it is desired to allow others to participate or view the session via conference device 202, but the user of user device 212 still wants to be able to utilize a camera or display of the user device 212 for the conference session.

In this paradigm, conference device 202 is only a peripheral device managed by user device 212 in a conference session. The conference session may be initiated without a conference device, and user devices may initiate the conference session as long as they are coupled to a network (network 270 in this example). Thus, a user may initiate or participate in the conference on-the-fly (i.e., in real-time), which greatly increases the flexibility of conferencing. In addition, with the capability of transferring the conference session to a conference device, the conference session can take advantage of a dedicated conferencing resource (i.e., conference device(s)) when it is feasible. Thus, the conference system is both flexible and efficient. Note, while the example illustrates only one conference device, multiple conference devices may be utilized for a conference session (e.g., each conference device managed by a user device). Also, the conference session may contain more than two participants, i.e., three or more user devices may be in a conference session and each user device may transfer its conference session to a conference device.

Supporting Proximity-Based Conference Session Transfer

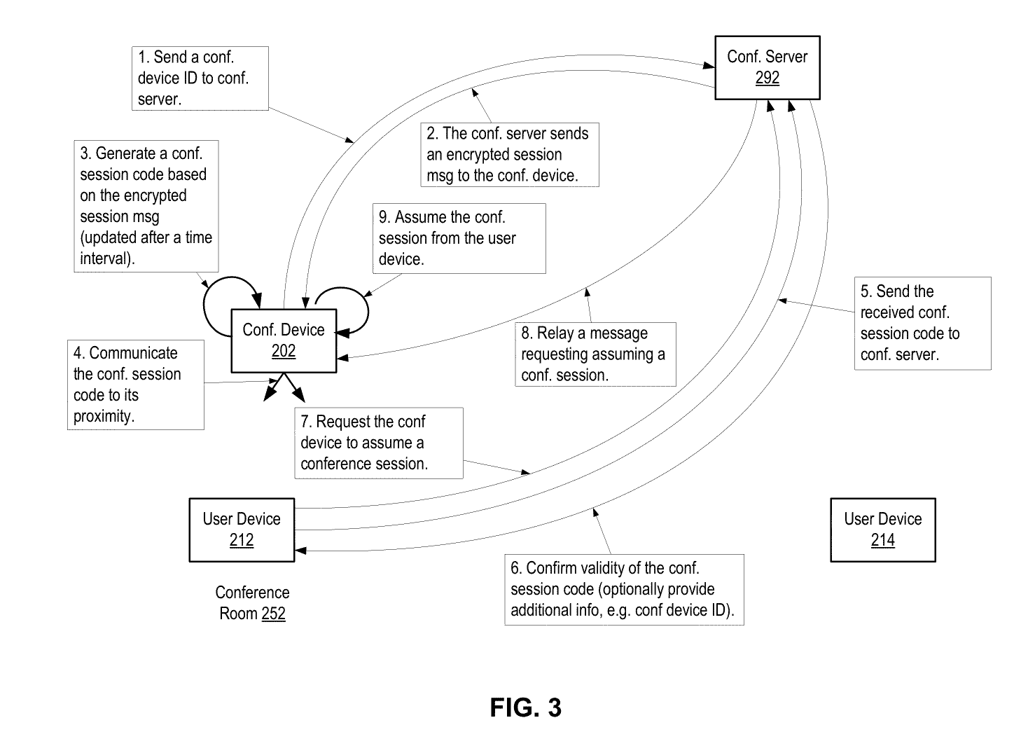

While the capability of transferring a conference session from a user device to a conference device is flexible and efficient, allowing all user devices to transfer conference sessions to a given conference device is chaotic and may not be suitable for many settings. FIG. 3 illustrates a process of supporting proximity-based conference session transfer according to one embodiment of the invention. Similar to FIG. 2, a conference session is initiated between user devices 212 and 214. Some connectivity between the different electronic devices is omitted in FIG. 3 for clarity of discussion. The process transfers the conference session from user device 212 to conference device 202. Task boxes 1 to 9 illustrate the order in which operations are performed according to one embodiment of the invention.

At task box 1, conference device 202 sends a conference device identifier (ID) to conference server 292. The conference device ID (CDID) is globally unique at conference server 292. The CDID can be a serial number, a media access control (MAC) address, an Internet Protocol (IP) address, another identifier, or a combination thereof. Conference device 202 may send out the CDID once at its system initiation, when it registers with conference server 292. The CDID of a conference device is static, and it generally does not change until an event occurs, for example, a registration of the conference device. Conference device 202 may send out the CDID periodically at a determined interval, in which case the sending of the CDID is similar to sending a keep-alive signal by the conference device. The sending of CDID may be self-initiated by conference device 202, and it may also be in response to an inquiry by conference server 292 or a third party electronic device.

At task box 2, conference server 292 generates a session identifier (ID) and sends an encrypted session message to conference device 202. The session ID may be generated based on the received CDID (as the session identified by the CDID is associated with the particular conference device) and one or more variables such as time of the day. While CDID is static for a given conference device, the session ID is dynamically changed. When only one conference session is allowable at a given time at conference device 202, the change of session ID provides a level of security. The session ID for a conference device may be changed after a period of time or occurrence of an event, for example, once a day/week or once a conference device reboots. When more than one conference session may be supported at conference device 202 simultaneously, a unique session ID is generated for each conference session to differentiate the sessions. Conference server 292 then encrypts the session ID and generates the conference session message. The encryption is a process of encoding the session ID so that only an authorized party (conference device 202 in this example) may be able to read the session ID. The encryption may add a cryptographic signature to the session ID. Persons skilled in the art understand that there are a variety of ways to encrypt the session ID.

At task box 3, conference device 202 receives the encrypted session message and decodes it, and it then generates a conference session code based on the encrypted session message. Conference device 202 knows the algorithm used by the conference server 292 to encrypt the session message (e.g., through the two parties exchanging the encryption keys), and thus it can decode the session message. After it decodes the session message, it generates a conference session code. Besides the encrypted session message, the conference session code may be based additionally on one or more variable such as timestamp of the present time at the conference device. The generation of a conference session code will be discussed in more details herein below.

At task box 4, conference device 202 communicates the conference session code within an area in its proximity. The communication is aimed at user device 212, which may use the conference session code to prove its proximity to conference device 202. The communication may take a variety of forms. For example, the conference session code may be broadcasted wirelessly so that a user device within a certain radius (e.g., a number of feet) of the conference device may be able to receive it. The conference session code may be displayed at a monitor coupled to the conference device 202 so that a user may be able to see the conference session code and use it to confirm the user's proximity to the conference device by entering the conference code to the user's user device.

Note, conference device 202 may generate several different conference session codes at task box 3, and in which case, the various conference session codes are communicated through different means in consideration of characteristics of different means of communication. For example, the conference session code being broadcasted wireless may be encrypted at a higher security level, and the conference session code may be longer as user device 212 is expected to receive the conference session code and process it without user intervention. On the other hand, the conference session code displayed at the monitor coupled to the conference device 202 may be shorter and encrypted at a lower security level as a user needs to be able to input it into user device 212. The different conference session codes may be communicated simultaneously.

Also, the conference session code may be updated at regular intervals where these intervals may be short time intervals (e.g., a few seconds). For example, each conference session code may be generated after the short time interval and be based on the received encrypted session message and a timestamp of the current time of updating. The short time interval is utilized to allow only a user device in the area in proximity to conference device 202 to have enough time to respond to the conference session code. In other words, conference device 202 expects only a user device in the area in its proximity to use the conference session code to redirect a conference session.

The area in the proximity of the conference device is often within a radius of a number of feet, where the monitor coupled to the conference device can be seen and heard in a video/audio conference session. The area of proximity may be limited naturally by physical surroundings of a conference device, e.g., within a conference room, and it may also be limited by implementation parameters, e.g., the power distribution level of a wireless signal through which the conference session code is sent. The wireless signal can be sent using any of a variety of protocols such as Wi-Fi, Bluetooth, and/or wireless local area network (WLAN) protocols.

Conference device 202 stays at task box 4 and communicates the conference session code to its proximity until a user device in an area of proximity to the conference device wants to transfer its conference session to conference device 202. In other words, as a peripheral device for a conference session, the conference device does not participate in a conference session until being requested.

At task box 5, after user device 212 receives the conference session code and once it plans to transfer its conference session to conference device 202, it sends the conference session code to conference server 292. As discussed, the conference session code may be wirelessly received from the conference device 202 in one embodiment, and a user may input the conference session code displayed at the monitor. The received conference session code is then sent to conference server 292. User device 212 may add a layer of encryption to the received conference session code when it sends the conference session code to conference server 292. The user device 212 does not have to be and likely is not on the same network as the conference device 202. For example, a user devices 212 may be a smartphone on a cellular network and the conference device 202 is a corporate device on a local area network. Further, the user device 212 in some embodiments can be a trusted member of the same domain as the conference device 202 or in other embodiments the user device can be a guest of the domain such as in a scenario where the user device 212 was invited to start a conference session by another user device that is part of the same domain as the conference device 202.

Conference server 292 then verifies the conference session code. As conference server 292 sends out the encrypted session message to the conference device earlier, conference server 292 knows the conference session ID and the cryptographic signature added to the session ID. It may not know the one or more additional variables (e.g., timestamp of the conference session code) which the conference session code may be based on, in which case conference server 292 tries out all possible variables. For example, when the additional variable is the timestamp of the conference session code, conference server 292 tries out all the timestamp around the time that conference device may send out the conference session code, considering a range of possible drift of clocks at the different devices.

Conference server 292 may confirm that the conference session code was sent by a valid conference device. At task box 6, conference server 292 confirms validity of the conference session code and optionally provides additional information about conference device 202. For example, conference server 292 may inform user device 212 of the CDID of conference device 202. If conference server 292 cannot confirm that the conference session code was sent by a valid conference device, it may return an error code to user device 212. In the alternative, conference server 292 may not send any message to user device 212 and only wait for user device 212 to send a new conference session code.

At task box 7, once user device 212 gets confirmation of the validity of the conference session code, user device 212 requests conference server 292 to coordinate conference device 202 to assume the conference session of user device 212.

At task box 8, conference server 292 sends a message to conference device 202 to request conference device 202 to assume the conference session of user device 212. Then at task box 9, conference device 202 assumes the conference session from user device 212. During the process, audio and video streams of the conference session of user device 212 will be redirected to conference device 202, and the audio/video function of the user device 212 may be disabled. User device 212 may control conference device 202 remotely to manage the conference session. In some embodiments, the full audio of all participants or any subset thereof can be automatically muted when the conference device 202 assumes the session to avoid having multiple audio capture devices in the same room that causes interference between these devices. In further embodiments, only the user devices that are known to be in proximity to the conference devices may be muted.

After the conference session transfer, user device 212 may share a user interface with other participants of the conference session (e.g., when the user device is a laptop computer, the desktop of the laptop computer may be displayed on a monitor coupled to the conference device). With a shared user interface, it will be easier for a user to present and explain to all the local (within the same location of the user) and remote (at another location of the conference session) participants. User device 212 may also perform other tasks while the conference session is redirected to the conference device, thus the transfer offers more flexibility to a user of the system.

Note that user device 212 does not directly request conference device 202 to assume the conference session, and it requests conference server 292 instead. A reason is that often conference device 202 and user device 212 belong to different networks (for example, conference device 202 is in an enterprise WiFi network while user device 212 is in a guest WiFi network), and it may be difficult for user device 212 to communicate with conference device 202 directly without the credential of the user device being established by the conference server (through steps in task boxes 5-7).

Through the process, because the conference session code is communicated only to an area in proximity to conference device 202, only user devices in the area in proximity to conference device 202 may know the conference session code. In addition, because the conference session code may be updated after a short time interval, the user devices have to be in the area in proximity at the particular time. A user device moved outside of the area cannot use an old conference session code to gain access to conference device 202, thus a conference device serves only user devices presently in the area in proximity to the conference device and it offers both security and convenience to the user devices.

Once the conference session is completed or even during the conference session is ongoing at conference device 202, user device 212 may halt the conference session transfer and resume the conference session at the user device through directing conference device 202 to disable its audio/video function relating to the conference session and enable the user device's audio/video session. After the conference session is removed from conference device 202, another user device in the area in proximity to the conference device may transfer its session to the conference device.

Messaging During A Proximity-Based Conference Session Transfer

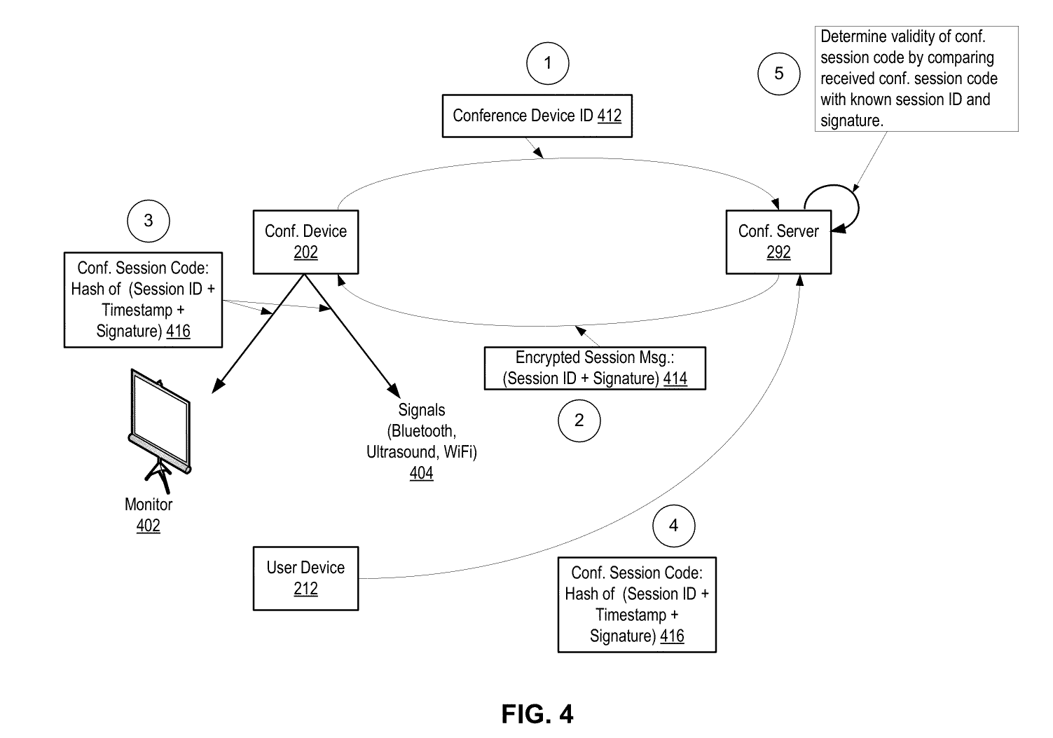

FIG. 4 illustrates messaging during a proximity-based conference session transfer according to one embodiment of the invention. FIG. 4 is similar to FIG. 3, and the same or similar references indicate the entities server the same or similar functions. Numbered cycles 1 to 5 illustrate the order in which various messages are generated and used according to one embodiment of the invention.

At cycle 1, the conference device ID (CDID) (at reference 412) is sent from conference device 202 to conference server 292. As discussed herein above, the CDID is globally unique at conference server 292. The CDID can be a serial number, a media access control (MAC) address, an Internet Protocol (IP) address, another identifier, or a combination thereof. The CDID of a conference device is static, and it generally does not change until the occurrence of an event, for example, an initiation of the conference device.

Based on the received CDID, at cycle 2, conference server 292 generates an encrypted session message (at reference 414). The encrypted session message contains a session ID and a cryptographic signature in one embodiment. The session ID may be generated based on CDID and one or more variables such as time of the day. While CDID is static for a given conference device, the session ID is more dynamic. The session ID for a conference device may be changed after a period of time or occurrence of an event, for example, once a day/week or when a conference device reboot occurs. Conference device 202 then encrypts the session ID and generates the session message. The encryption may add a cryptographic signature to the session ID.

Based on the received encrypted session message, at cycle 3, conference device 202 generates a conference session code. In one embodiment, the conference session code is a hash of a session ID, a timestamp, and a cryptographic signature as illustrated at reference 416. The hash is an algorithm that maps data of various length to data of a fixed length, and persons skilled in the art understand there are a variety of ways to hash the session ID, the timestamp, and the cryptographic signature to generate the conference session code.

Conference device 202 then communicates the conference session code to an area in proximity to itself. The communication may be through display at monitor 402 coupled to the conference device. It may be through sending out signals such as ultrasound or radio frequency (RF) signals, Bluetooth signals, WiFi signals, or other forms of wireless signals at reference 404. The displayed conference session codes at monitor 402 and at transmitted one at reference 404 may be different for the same encrypted session message. The difference is due to the different characteristics of the means—the displayed conference session code needs to be entered by a user to user device 212, while the transmitted conference session code may be received by the user device 212 directly without user intervention.

At cycle 4, the conference session code is sent to conference server 292. At cycle 5, conference server 292 determines validity of the received conference session code by comparing it with known session ID and the cryptographic signature. While conference server 292 does not know the timestamp used in hashing, it tries all viable timestamps and determines if one viable timestamp exists to make the conference session code valid, considering a range of possible drift of the clock at the different devices.

Initiation of the Conference Device

As discussed herein above, after a conference session transfer, user device 212 may control conference device 202 remotely to manage the conference session. With the remote management by a user device, a conference device can perform its conferencing function without the need of a separate remote control device. In other words, a user device performs all control functions remotely. While the feature makes the conference device easier to use, it presents a challenge in setting up or initiating the conference device.

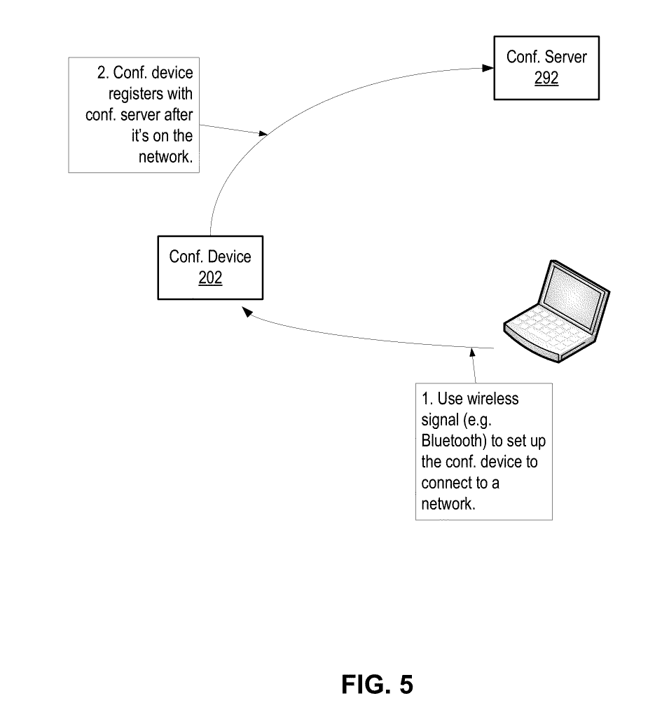

FIG. 5 illustrates initiating a conference device according to one embodiment of the invention. FIG. 5 uses the same reference numbers for the same entity as FIGS. 2-4. Task boxes 1 to 9 illustrate the order in which operations are performed according to one embodiment of the invention.

At task box 1, a computer uses wireless signal such as Bluetooth signal to set up the conference device to connect to a network. When the conference device is powered up, it is not connected to any network, and it needs networking provisioning to function. The computer may communicate with the conference device wirelessly and provide information needed for the conference device to connect to a network. For example, the computer may provide a way for the conference device to obtain an IP address, a gateway address, a subnet address, and etc.

At task box 2, after the conference device gets on the network, it registers with conference server 292. After registration, the conference device completes its initiation process and can assume a conference session as discussed herein above relating to FIGS. 2-4.

Flow Diagrams for Embodiments of Supporting Prioritization

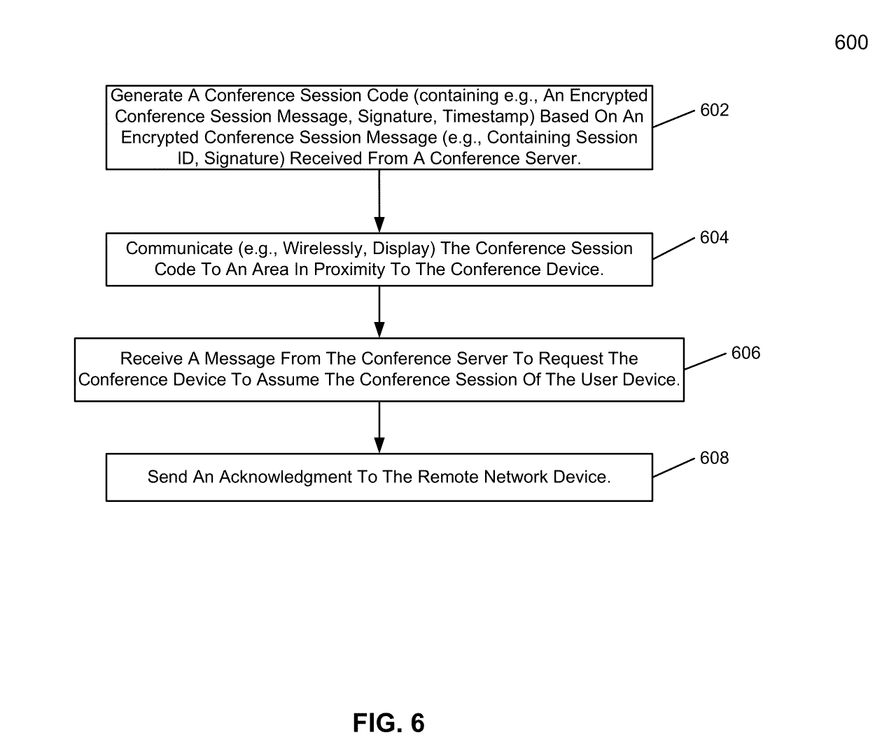

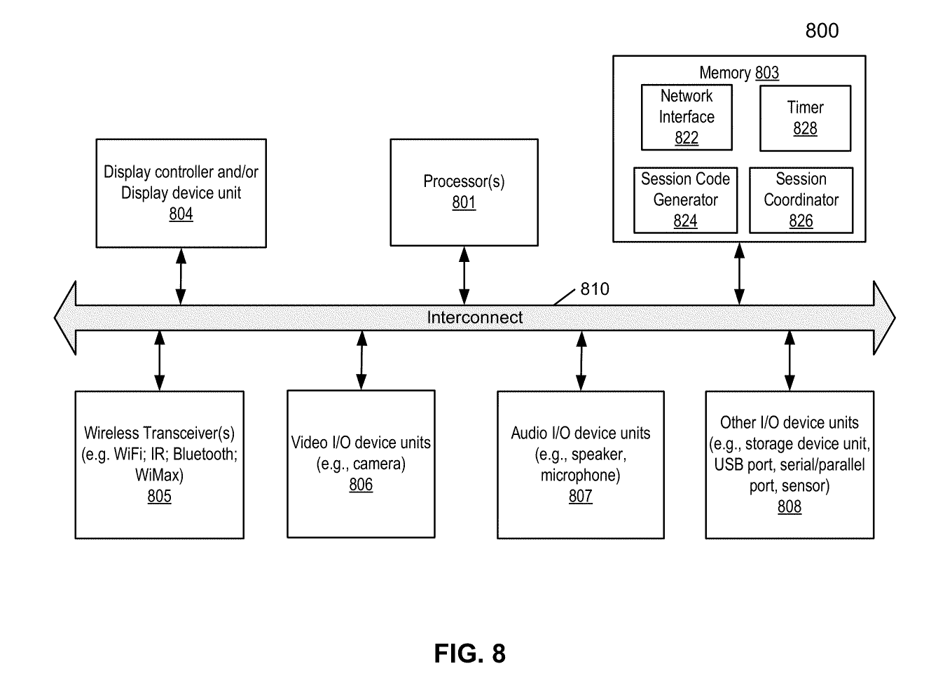

FIG. 6 is a flow diagram illustrating a process of supporting proximity-based conference session transfer at a conference device according to one embodiment of the invention. Method 600 may be implemented at a conference device illustrated in FIG. 8. The conference device may be coupled to a network such as network 207, and the network may be coupled to a conference server such as conference server 292, user devices 212 and 214, all discussed herein (e.g., in discussion relating to FIG. 2).

At reference 602, the conference device generates a conference session code based on an encrypted conference session message received from the conference server. In one embodiment, the encrypted conference session message contains a session identifier identifying a session associated with the conference device, and a cryptographic signature to encrypt the conference session message. In one embodiment, the encrypted conference session message is generated at the conference server, where the conference server receives a conference device identifier of the conference device, and it generates the encrypted conference session message based on the conference device identifier. Note the encrypted conference session message is updated after a period of time (e.g., once a day/week) or occurrence of an event (e.g., reboot of the conference device).

The conference session code is generated based on the encrypted conference session message and one or more variables such as timestamp of current time at the conference device. Note the conference session code is updated after a short time interval (e.g., a few seconds), and the short time interval is utilized to allow only the user device in the area in proximity to the conference device to have time to respond to the communicated conference session code.

At reference 604, the conference device communicates the conference session code to the area in proximity to the conference device. The area in proximity to the conference device is often within a certain radius (e.g., a number of feet) of the conference device. Depending on the characteristics of different means of communication, the conference session code may be communicated differently. For example, the conference session code may be broadcasted through ultrasound, RF, WiFi, or Bluetooth protocols. The radius of the broadcast may be chosen to allow only the conference devices in the defined area in proximity to the conference device to be able to receive the broadcasted conference session code. The conference session code may be displayed at a monitor coupled to the conference device so that a user may be able to see the conference session code and use it to confirm the user's proximity to the conference device by entering the conference code to the user's user device. Note that the conference device contains a monitor in one embodiment.

A user device in the area in proximity to the conference device receives the conference session code, and it then requests the conference server to coordinate with the conference device to assume a conference session of the user device. The conference server in turn sends a message to the conference device to request the conference device to assume the conference session of the user device.

At reference 606, the conference device receives the message from the conference server requesting the conference device to assume the conference session of the user device.

Then at reference 608, the conference device assumes the conference session of the user device by performing conference functions according to input from the user device. The assumption of the conference session of the user device also generally involves disabling the conference functions of the user device. However, in other embodiments the user device remains a participant in the conference session.

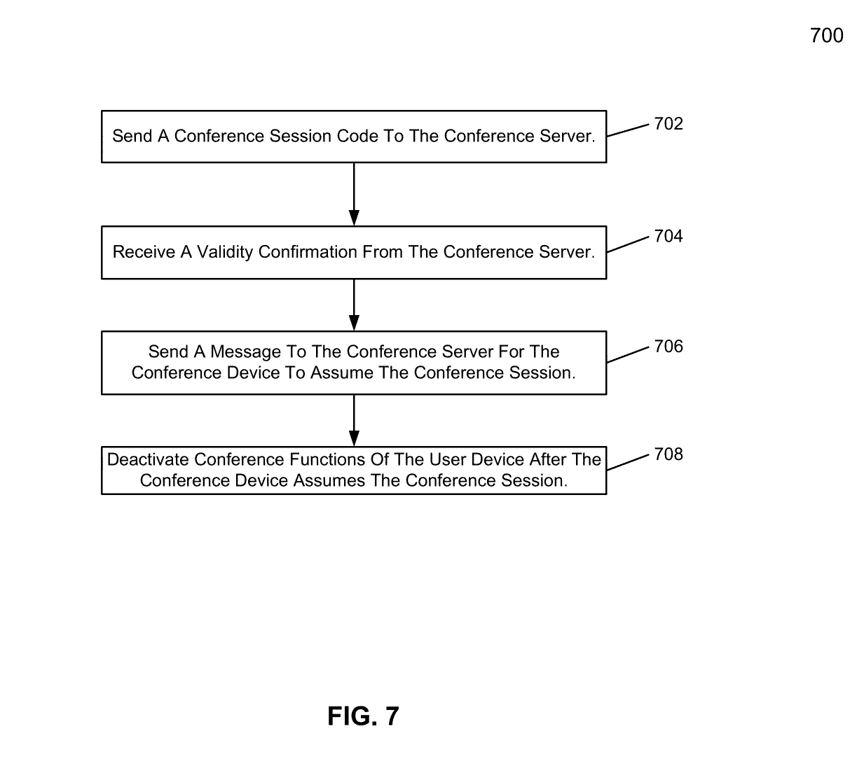

FIG. 7 is a flow diagram illustrating a process of supporting proximity-based conference session transfer at a user device according to one embodiment of the invention. Method 700 may be implemented at a user device described herein above, and the user device is coupled to a network such as network 207, and the network may be coupled to a conference server such as conference server 292, and conference device 202, all discussed herein (e.g., in discussion relating to FIG. 2).

Method 700 starts with the user device receiving a conference session code from a conference device. As discussed herein above, the user device is in an area in proximity to the conference device. The user device has an ongoing conference session and a user of the user device wants to redirect the conference session from the user device to the conference device.

At reference 702, after receiving the conference session code from the conference device, the user device sends the conference session code to the conference server. The conference server then verifies whether the conference session code was sent by a valid conference device by determining the validity of the conference session code. The conference server is able to verify the conference session code because earlier it sent out the conference session message, from which the conference device generates the conference session code. The conference server only needs to determine the one or more variables (e.g. timestamp) added to the conference session code.

When the conference server determines that the conference session code is valid, it sends out a validity confirmation to the conference device. At reference 704, the conference device receives the validity confirmation. Then at reference 706, the user device sends a message to the conference server for the conference device to assume the conference session. The conference server then sends the message to the conference device to request the conference device to assume the conference session of the user device. The conference device then assumes the conference session of the user device by performing conference functions according to input from the user device. At reference 708, the user device deactivates conference functions of the user device for the conference session after the conference device assumes the conference session.

Electronic Devices Implementing Proximity-Based Conference Session Transfer

FIG. 8 is a block diagram illustrating an example of a conference device that may be used with one embodiment of the invention. For example, system 800 may represent any of the conference device described above performing any of the processes or methods described above. System 800 can include many different components. These components can be implemented as integrated circuits (ICs), portions thereof, discrete electronic devices, or other modules adapted to a circuit board such as a motherboard or add-in card of a computing system, or as components otherwise incorporated within a chassis of the computing system. Note also that system 800 is intended to show a high level view of many components of the computing system. However, it is to be understood that additional components may be present in certain implementations and furthermore, different arrangement of the components shown may occur in other implementations.

In one embodiment, system 800 includes processor 801, memory 803, and device units 805-808 that are interconnected via a bus or an interconnect 810. Processor 801 may represent a single processor or multiple processors with a single processor core or multiple processor cores included therein. Processor 801 may represent one or more general-purpose processors such as a microprocessor, a central processing unit (CPU), or processing device. More particularly, processor 801 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 801 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 801, which may be a low power multi-core processor socket such as an ultra low voltage processor, may act as a main processing unit and central hub for communication with the various components of the system. Such a processor can be implemented as a system on chip (SoC). Processor 801 is configured to execute instructions for performing the operations and steps discussed herein. System 800 further includes a graphics interface that communicates with display controller 804, which is a part of a graphics subsystem that may include the display controller and/or a display device such as a monitor (e.g., a television).

Processor 801 may communicate with memory 803, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 that will offer extensions to LPDDR2 to increase bandwidth. As examples, 2/4/8 gigabytes (GB) of system memory may be present and can be coupled to processor 801 via one or more memory interconnects. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector.

Memory 803 may include one or more volatile storage (or memory) devices such as random access memory (RAM), dynamic RAM (DRAM), synchronous DRAM (SDRAM), static RAM (SRAM), or other types of storage devices. Memory 803 may store information including sequences of instructions that are executed by processor 801, or any other device units. For example, executable code and/or data of a variety of operating systems, device drivers, firmware (e.g., input output basic system or BIOS), and/or applications can be loaded in memory 803 and executed by processor 801. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 800 may further include IO devices such as device units 805-808, including wireless transceiver(s) 805, video IO device unit(s) 806, audio IO device unit(s) 807, and other IO device units 808. Wireless transceiver 805 may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. System 800 may also include an ultrasound device unit (not shown) for transmitting a conference session code.

Video IO device unit 806 may include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips and conferencing. Audio IO device unit 807 may include a speaker and/or a microphone to facilitate voice-enabled functions, such as voice recognition, voice replication, digital recording, and/or telephony functions. Other optional devices 908 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional device units 808 may further include certain sensors coupled to interconnect 810 via a sensor hub (not shown), while other devices such as a keyboard or thermal sensor may be controlled by an embedded controller (not shown), dependent upon the specific configuration or design of system 800.

To provide for persistent storage of information such as data, applications, one or more operating systems and so forth, a mass storage (not shown) may also couple to processor 801. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 801, e.g., via a serial peripheral interface (SPI). This flash device may provide for non-volatile storage of system software, including a basic input/output software (BIOS) as well as other firmware of the system.

System 800 may be coupled to a network such as network 207, and the network may be coupled to a conference server such as conference server 292, user devices 212 and 214, all discussed herein (e.g., in discussion relating to FIG. 2). System 800 may perform methods discussed herein above relating to FIGS. 6 and 7.

In one embodiment, processor 801 of system 800 is configured to execute code stored in memory 803. The code includes network interface 822, session code generator 824, session coordinator 826, and timer 828. Network interface 822 is configured to receive an encrypted conference session message from a conference server. Session code generator 824 is configured to generate a conference session code based on the encrypted conference session message from a conference server. Session code generator 824 is configured to generate the conference session code further based on a timestamp (e.g., the current time of system 800) in one embodiment. Network interface 822 is then configured to communicate the conference session code to an area in proximity to the conference device, where a user device in the area in proximity of the conference device receives the conference session code and requests the conference server to coordinate the conference device to assume a conference session of the user device. The conference session code may be communicated through display controller 804, which causes a monitor coupled to system 800 to display the conference session code, ultrasound device unit, and/or wireless transceiver 805 that causes the conference session code to be sent through a wireless signal. Timer 828 is configured to set a short time interval (e.g., several seconds), and the conference session code is updated after the short time interval expires. The short time interval is selected aiming at allowing only the user device in the area in proximity to the conference device to have time to respond to the communicated conference session code.

The user device receives the communicated conference session code, and it then requests the conference server to coordinate the conference device to assume a conference session of the user device. The conference server in turn sends a message to the conference device to request the conference device to assume the conference session of the user device. Through network interface 822, the conference device receives the message. The conference device then assumes the conference session of the user device through session coordinator 826 by coordinating conference functions according to input from the user device. The coordinating conference functions are performed through coordinating components such as display control 804, video I/O device units 806, audio I/O device units 807 and etc.

Note that while system 800 is illustrated with various components of a conference device, it is not intended to represent any particular architecture or manner of interconnecting the components; as such details are not germane to embodiments of the present invention. It will also be appreciated that a conference device having fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in conferencing technology to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a conference device, or similar electronic computing device, that manipulates and transforms data represented as physical (electronic) quantities within the conference device's registers and memories into other data similarly represented as physical quantities within the conference device's memories or registers or other such information storage, transmission or display devices.

Note the operations of the flow diagrams in FIGS. 6 and 7 are described with reference to the exemplary embodiment of FIG. 8. However, it should be understood that the operations of flow diagrams can be performed by embodiments of the invention other than those discussed with reference to FIG. 8, and the embodiments discussed with reference to FIG. 8 can perform operations different than those discussed with reference to the flow diagrams of FIGS. 6 and 7.

While the flow diagrams in the figures herein above show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method implemented at a conference device, the method comprising:
generating a conference session code based on an encrypted conference session message received from a conference server;
communicating the conference session code to an area in proximity to the conference device, wherein a user device in the area in proximity to the conference device receives the conference session code and requests the conference server to coordinate the conference device to assume a conference session of the user device;
receiving a message from the conference server requesting the conference device to assume the conference session of the user device; and
assuming the conference session of the user device by performing conference functions according to input from the user device.

2. The method of claim 1, wherein the encrypted conference session message contains a session identifier and a cryptographic signature.

3. The method of claim 1, wherein the conference session code is updated after a short time interval, and wherein the short time interval is selected aiming at allowing only the user device in the area in proximity to the conference device to have time to respond to the communicated conference session code.

4. The method of claim 1, wherein the conference session code is generated further based on a timestamp.

5. The method of claim 1, wherein the conference session code is communicated to the area in proximity to the conference device through a wireless signal.

6. The method of claim 1, wherein the conference session code is communicated to the area in proximity to the conference device through displaying the conference session code to a monitor coupled to the conference device.

7. The method of claim 1, wherein the conference server generates the encrypted conference session message through:
receiving a conference device identifier of the conference device; and
generating the encrypted conference session message based on the conference device identifier, wherein the encrypted conference session message is updated after a period of time.

8. The method of claim 1, wherein the user device requesting the conference server to coordinate the conference device to assume the conference session of the user device comprising:
sending the conference session code to the conference server;
receiving a validity confirmation from the conference server;
sending the message to the conference server for the conference device to assume the conference session; and
deactivating conference functions of the user device for the conference session after the conference device assumes the conference session.

9. An apparatus serving as a conference device comprising:
a memory configured to store data and instructions; and
a processor configured to execute a network interface, a session code generator, and a session coordinator stored in the memory,
the network interface configured to receive an encrypted conference session message from a conference server and communicate a conference session code to an area in proximity to the apparatus, wherein a user device in the area in proximity to the apparatus receives the conference session code and requests the conference server to coordinate the conference device to assume a conference session of the user device, and the network interface further configured to receive a message from the conference server requesting the apparatus to assume the conference session of the user device,
the session code generator configured to generate the conference session code based on the received encrypted conference session message, and
the session coordinator configured to assume the conference session of the user device by coordinating conference functions according to input from the user device.

10. The apparatus of claim 9, wherein the encrypted conference session message contains a session identifier and a cryptographic signature.

11. The apparatus of claim 9, wherein the processor is further configured to execute a timer that counts a short time interval, wherein the conference session code is updated after the short time interval expires, and wherein the short time interval is selected aiming at allowing only the user device in the area in proximity to the conference device to have time to respond to the communicated conference session code.

12. The apparatus of claim 9, wherein the session code generator is configured to generate the conference session code further based on a timestamp.

13. The apparatus of claim 9, wherein the network interface is configured to cause communicating the conference session code to the area in proximity to the apparatus through a wireless signal.

14. The apparatus of claim 9, wherein the network interface is configured to cause communicating the conference session code to the area in proximity to the apparatus through displaying the conference session code to a monitor coupled to the apparatus.

15. The apparatus of claim 9, wherein the conference server generates the encrypted conference session message through:
receiving a conference device identifier of the conference device; and
generating the encrypted conference session message based on the conference device identifier, wherein the encrypted conference session message is updated after a period of time.

16. A non-transitory machine-readable medium having instructions stored therein, which when executed by a processor, cause the processor to perform operations at a conference device, the operations comprising:
generating a conference session code based on an encrypted conference session message received from a conference server;
communicating the conference session code to an area in proximity to the conference device, wherein a user device in the area in proximity to the conference device receives the conference session code and requests the conference server to coordinate the conference device to assume a conference session of the user device;
receiving a message from the conference server requesting the conference device to assume the conference session of the user device; and
assuming the conference session of the user device by performing conference functions according to input from the user device.

17. The non-transitory machine-readable medium of claim 16, wherein the encrypted conference session message contains a session identifier and a cryptographic signature.

18. The non-transitory machine-readable medium of claim 16, wherein the conference session code is updated after a short time interval, and wherein the short time interval is selected aiming at allowing only the user device in the area in proximity to the conference device to have time to respond to the communicated conference session code.

19. The non-transitory machine-readable medium of claim 16, wherein the conference session code is generated further based on a timestamp.

20. The non-transitory machine-readable medium of claim 16, wherein the conference session code is communicated to the area in proximity to the conference device through displaying the conference session code to a monitor coupled to the conference device.
